(19) United States
(12) Patent Application Publication
(10) Pub. No.: US 2022/0006816 A1
(43) Pub. Date: Jan. 6, 2022

(54) TERMINAL MANAGEMENT AND CONTROL METHOD, APPARATUS, AND SYSTEM

(71) Applicant: HUAWEI TECHNOLOGIES CO., LTD., Shenzhen (CN)

(72) Inventor: Jingwang MA, Shanghai (CN)

(21) Appl. No.: 17/481,921

(22) Filed: Sep. 22, 2021

Related U.S. Application Data
(63) Continuation of application No. PCT/CN2020/080639, filed on Mar. 23, 2020.

(30) Foreign Application Priority Data
Mar. 22, 2019 (CN) 201910224183.8

(51) Int. Cl. H04L 29/06; H04L 12/26; H04W 12/08

(52) U.S. Cl. CPC H04L 63/104; H04W 12/08; H04L 43/16; H04L 43/06

(57) ABSTRACT

To manage and control a communication behavior of a terminal and ensure communication security of the terminal, this application provides a terminal management and control method, an apparatus, and a system. The method includes: a session management network element obtains authorized communication information of a first terminal or a terminal group, where the authorized communication information includes information about a device with which the first terminal or the terminal group is allowed to communicate; when the first terminal or a second terminal in the terminal group communicates with a device not listed in the authorized communication information, the session management network element learns that a management and control measure needs to be taken on communication of the first terminal or the second terminal; and the session management network element takes the management and control measure.

### CROSS-REFERENCE TO RELATED APPLICATIONS

This application is a continuation of International Application No. PCT/CN2020/080639, filed on Mar. 23, 2020, which claims priority to Chinese Patent Application No. 201910224183.8, filed on Mar. 22, 2019. The disclosures of the aforementioned applications are hereby incorporated by reference in their entireties.

### TECHNICAL FIELD

This application relates to the field of communication technologies, and in particular, to a terminal management and control method, an apparatus, and a system.

### BACKGROUND

A 5th generation (5G) communication system fully supports vertical fields, such as transportation, energy, video entertainment, industries, smart cities, healthcare, agriculture, finance, and education. In these fields, new technologies based on advanced 5G networks, sensors, artificial intelligence, Internet of Things, and the like greatly improve industry efficiency and bring infinite business opportunities. These new technologies are used in scenarios such as ports, hospitals, railways, and factories. Service requirements of the vertical industries are that a mobile network provides data connections that meet service requirements (on reliability, rate, and the like) and the network exposes capabilities to the vertical industries. In these vertical industries, a large quantity of terminals such as a mobile robot, an automated guided vehicle (AGV), a vehicle, a device on a. train, a sensor, and a control device, are scattered. In the current technology, there is no corresponding method for managing and controlling the communication behavior of these terminals.

### SUMMARY

To manage and control a communication behavior of a terminal and ensure communication security of the terminal, this application provides a terminal management and control method, an apparatus, and a system.

According to a first aspect, this application provides a terminal management and control method, including: a session management network element obtains authorized communication information of a first terminal or a terminal group, where the authorized communication information includes information about a device with which the first terminal or the terminal group is allowed to communicate; when the first terminal or a second terminal in the terminal group communicates with a device not listed in the authorized communication information, the session management network element learns that a management and control measure needs to be taken on communication of the first terminal or the second terminal; and the session management network element takes the management and control measure.

According to the foregoing method, the session management network element obtains the authorized communication information of the first terminal or the terminal group, and when the first terminal or the second terminal in the terminal group communicates with the device not listed in the authorized communication information, the session management network element learns that the management and control measure needs to be taken on the first terminal or the second terminal in the terminal group. According to the method, a terminal communicates with a device listed in the authorized communication information, and a communication behavior of the terminal is managed and monitored, thereby ensuring stability and security of terminal communication.

In a possible design, the management and control measure includes any one or more of the following: performing packet discarding processing on data, where the data is data exchanged by the first terminal or the second terminal with the device not listed in the authorized communication information; when a quantity of times that the first terminal or the second terminal in the terminal group communicates with the device not listed in the authorized communication information exceeds a preset value, performing the packet discarding processing on the data; performing reporting to a third-party device, where the third-party device is a device that manages the first terminal or the terminal group; and when the quantity of times that the first terminal or the second terminal in the terminal group communicates with the device not listed in the authorized communication information exceeds the preset value, performing the reporting to the third-party device.

In the foregoing possible design, the management and control measure includes performing the packet discarding processing on the data, and that the session management network element takes the management and control measure includes: the session management network element sends a notification to a user plane network element, where the notification is used to indicate to delete the data. In this way, after receiving the notification, the user plane network element deletes the data exchanged by the first terminal or the second terminal with the device not listed in the authorized communication information, so that the terminal communicates with the device listed in the authorized communication information, and the communication behavior of the terminal is managed and monitored, thereby ensuring stability and security of terminal communication.

In the foregoing possible design, the management and control measure includes performing the packet discarding processing on the data, and that the session management network element takes the management and control measure includes: the session management network element deletes the data. In this way, the session management network element deletes the data exchanged by the first, terminal or the second terminal with the device not listed in the authorized communication information, so that the terminal communicates with the device listed in the authorized communication information, and the communication behavior of the terminal is managed and monitored, thereby ensuring stability and security of terminal communication.

In the foregoing possible design, the management and control measure includes performing the reporting to the third-party device, and the session management network element takes the management and control measure includes: the session management network element generates report information, and sends the report information to the third-party device, where the report information is used to indicate that the first terminal or the second terminal communicates with the device not listed in the authorized communication information; or the session management network element receives the report information from the user plane network element, and sends the report information to the third-party device. In this way, after learning of an exception, the third-party device may take a corresponding measure, for example, return the terminal to a factory for maintenance, so that the terminal communicates with the device listed in the authorized communication information, and the communication behavior of the terminal is managed and monitored, thereby ensuring stability and security of terminal communication.

In a possible design, that the session management network element learns that the management and control measure needs to be taken on the first terminal or the second terminal includes: the session management network element learns, by receiving the report information from the user plane network element, that the management and control measure needs to be taken on the first terminal or the second terminal, where the report information is used to indicate that the first terminal or the second terminal communicates with the device not listed in the authorized communication information.

In a possible design, that the session management network element learns that the management and control measure needs to be taken on the first terminal or the second terminal includes: the session management network element learns, by receiving the data, that the management and control measure needs to be taken on the first terminal or the second terminal, where the data is the data exchanged by the first terminal or the second terminal with the device not listed in the authorized communication information, and the data carries information about the device not listed in the authorized communication information.

In a possible design, the session management network element receives indication information from the third-party device, where the indication information is used to indicate that the management and control measure is taken when the first terminal or the second terminal communicates with the device not listed in the authorized communication information.

In the foregoing possible design, that the session management network element takes the management and control measure includes: the session management network element takes the management and control measure based on the indication information.

In a possible design, that the session management network element obtains the authorized communication information of the first terminal or the terminal group includes: the session management network element obtains the authorized communication information that is of the first terminal or the terminal group and that is from the third-party device; or the session management network element locally obtains the authorized communication information of the first terminal or the terminal group.

According to a second aspect, this application provides a terminal management and control method, including: a user plane network element obtains authorized communication information of a first terminal or a terminal group, where the authorized communication information includes information about a device with which the first terminal or the terminal group is allowed to communicate; the user plane network element detects that the first terminal or a second terminal in the terminal group communicates with a device not listed in the authorized communication information; and the user plane network element takes a management and control measure on communication of the first terminal or the second terminal.

According to the foregoing method, the user plane network element obtains the authorized communication information of the first terminal or the terminal group, and takes the management and control measure when detecting that the first terminal or the second terminal in the terminal group communicates with the device not listed in the authorized communication information. According to the method, a terminal communicates with a device listed in the authorized communication information, and a communication behavior of the terminal is Managed and monitored, thereby ensuring stability and security of terminal communication.

In a possible design, that the user plane network element detects that the first terminal or a second terminal communicates with a device not listed in the authorized communication information includes: the user plane network element receives data, where the data is data exchanged by the first terminal or the second terminal with the device not listed in the authorized communication information, and the data carries information about the device not listed in the authorized communication information; and the user plane network element detects, based on the information about the device not listed in the authorized communication information, that the first terminal or the second terminal communicates with the device not listed in the authorized communication information.

In the foregoing possible design, the management and control measure includes any one or more of the following: performing packet discarding processing on the data; when a quantity of times that the first terminal or the second terminal in the terminal group communicates with the device not listed in the authorized communication information exceeds a preset value, performing the packet discarding processing on the data; performing reporting to a third-party device, where the third-party device is a device that manages the first terminal or the terminal group; and when the quantity of times that the first terminal or the second terminal in the terminal group communicates with the device not listed in the authorized communication information exceeds the preset value, performing the reporting to the third-party device.

When the management and control measure includes performing the packet discarding processing on the data, that the user plane network element takes a management and control measure includes: the user plane network element sends report information to a session management network element, where the report information is used to indicate that the first terminal or the second terminal communicates with the device not listed in the authorized communication information; the user plane network element receives a notification from the session management network element, where the notification is used to indicate to delete the data; and the user plane network element deletes the data based on the notification. In this way, after receiving the notification, the user plane network element deletes the data exchanged by the first terminal or the second terminal with the device not listed in the authorized communication information, so that the terminal communicates with the device listed in the authorized communication information, and the communication behavior of the terminal is managed and monitored, thereby ensuring stability and security of terminal communication.

When the management and control measure includes performing reporting to the third-party device, that the user plane network element takes a management and control measure includes: The user plane network element sends report information to the third-party device, where the report information is used to indicate that the first terminal or the second terminal communicates with the device not listed in the authorized communication information. In this way, after learning of an exception, the third-party device may take a corresponding measure, for example, return the terminal to a factory for maintenance, so that the terminal communicates with the device listed in the authorized communication information, and the communication behavior of the terminal is managed and monitored, thereby ensuring stability and security of terminal communication.

In a possible design, that the user plane network element obtains authorized communication information of a first terminal or a terminal group includes: the user plane network element obtains the authorized communication information that is of the first terminal or the terminal group and that is from the third-party device; or the user plane network element locally obtains the authorized communication information of the first terminal or the terminal group,

In a possible design, the user plane network element further receives indication information from a third-party device, where the indication information is used to indicate that the management and control measure is taken when the first terminal or the second terminal communicates with the device not listed in the authorized communication information.

In the foregoing possible design, that the user plane network element takes a management and control measure includes: the user plane network element takes the management and control measure based on the indication information.

In a possible design, the authorized communication information according to the first aspect or the second aspect includes any one or more of the following: an identifier of a device with which the first terminal or the terminal group is allowed to communicate; an internet protocol IP address of a device with which the first terminal or the terminal group is allowed to communicate; a media access control MAC address of a device with which the first terminal or the terminal group is allowed to communicate; an identifier of an application with which the first terminal or the terminal group is allowed to communicate; and a server network address of an application with which the first terminal or the terminal group is allowed to communicate.

According to a third aspect, this application provides a session management network element. The session management network element has a function of implementing the method in the first aspect, The function may be implemented by hardware, or may be implemented by hardware by executing corresponding software. The hardware and software include one or more modules corresponding to the foregoing function.

In a possible design, a structure of the session management network element includes a processing unit and a communication unit. The processing unit is configured to support the session management network element in performing the method in the first aspect, and the communication unit is configured to support communication between the session management network element and another device. The session management network element may further include a storage unit, where the storage unit is configured to be coupled to the processing unit, and stores program instructions and data that are necessary for the session management network element, In an example, the processing unit may be a processor, the communication unit may be a transceiver, and the storage unit may be a memory,

In the foregoing possible design, the communication unit includes a receiving unit and a sending unit. These units may perform the method in the first aspect. For details, refer to detailed descriptions in the method example. Details are not described again.

According to a fourth aspect, this application provides an apparatus (for example, the apparatus may be a chip system). The apparatus includes a processor, and may perform the method in the first aspect.

In a possible design, the apparatus further includes a memory, where the memory is configured to store necessary program instructions and data.

According to a fifth aspect, this application further provides a computer program product. When the computer program product runs on a computer, the computer is enabled to perform the method in the first aspect.

According to a sixth aspect, a computer-readable storage medium is provided. The computer-readable storage medium stores instructions. When the instructions are run on a computer, the computer is enabled to perform the method in the first aspect.

According to a seventh aspect, this application provides a user plane network element. The user plane network element has a function of implementing the method in the second aspect. The function may be implemented by hardware, or may be implemented by hardware by executing corresponding software. The hardware and software include one or more modules corresponding to the foregoing function.

In a possible design, a structure of the user plane network element includes a processing unit and a communication unit. The processing unit is configured to support the user plane network element in performing the method in the second aspect, and the communication unit is configured to support communication between the user plane network element and another device. The user plane network element may further include a storage unit, where the storage unit is configured to be coupled to the processing unit, and stores program instructions and data that are necessary for the user plane network element. In an example, the processing unit may be a processor, the communication unit may be a transceiver, and the storage unit may be a memory.

In the foregoing possible design, the communication unit includes a receiving unit and a sending unit. These units may perform the method in the second aspect. For details, refer to detailed descriptions in the method example. Details are not described again.

According to an eighth aspect, this application provides an apparatus (for example, the apparatus may be a chip system). The apparatus includes a processor, and may perform the method in the second aspect

In a possible design, the apparatus further includes a memory, where the memory is configured to store necessary program instructions and data.

According to a ninth aspect, this application further provides a computer program product. When the computer program product runs on a computer, the computer is enabled to perform the method in the second aspect.

According to a tenth aspect, a computer-readable storage medium is provided. The computer-readable storage medium stores instructions. When the instructions are run on a computer, the computer is enabled to perform the method in the second aspect.

According to an eleventh aspect, this application provides a communication system. The system includes one or both of the session management network element in the first aspect and the user plane network element in the second aspect.

In a possible design, the communication system may further include another device that interacts with the session management network element and the user plane network element in the solutions provided in the embodiments of this application, for example, a third-party device or a terminal.

### BRIEF DESCRIPTION OF DRAWINGS

FIG. 1 is a schematic diagram of a network architecture according to an embodiment of this application;

FIG. 2 is a schematic diagram of a 5G network architecture according to an embodiment of this application;

FIG. 3 is a flowchart of a terminal management and control method according to an embodiment of this application;

FIG. 4 is a flowchart of another terminal management and control method according to an embodiment of this application;

FIG. 5 is a flowchart of another terminal management and control method according to an embodiment of this application;

FIG. 6 is a flowchart of another terminal management and control method according to an embodiment of this application;

FIG. 7 is a schematic structural diagram of a communication device according to an embodiment of this application;

FIG. 7a is a schematic structural diagram of a session management network element according to an embodiment of this application;

FIG. 7b is a schematic structural diagram of a user plane network element according to an embodiment of this application; and

FIG. 8 is a schematic structural diagram of another communication device according to an embodiment of this application.

### DESCRIPTION OF EMBODIMENTS

To make objectives, technical solutions, and advantages of this application clearer, the following describes the technical solutions in the embodiments of this application with reference to accompanying drawings. In the descriptions of this application, “/” represents an “or” relationship between associated objects unless otherwise specified. For example, A/B may represent A or B. The term “and/or” indicates only an association relationship for describing associated objects and indicates that three relationships may exist. For example, A and/or B may indicate the following three cases: Only A exists, both A and B exist, and only B exists, where A and B may be singular or plural. In addition, in the descriptions of this application, unless otherwise specified, “a plurality of” means two or more than two. The term “at least one item (piece) of the following” or a similar expression thereof refers to any combination of these items, including any combination of a singular item (piece) or plural items (pieces). For example, at least one of a, b, or c may indicate: a, b, c, a and b, a and c, b and c, or a, b, and c, where a, b, and c may be singular or plural. In addition, to clearly describe the technical solutions in the embodiments of this application, terms such as “first” and “second” are used in the embodiments of this application to distinguish between functions and purposes. A person skilled in the art may understand that the terms such as “first” and “second” do not intend to limit a quantity or an execution sequence, and the terms such as “first” and “second” do not indicate a definite difference.

The technical solutions in the embodiments of this application may be used in various communication systems, for example, a global system for mobile communications (GSM), a code division multiple access (CDMA) system, a wideband code division multiple access (WCDMA) system, a general packet radio service (GPRS), a long-term evolution (LTE) system, an LTE frequency division duplex (FDD) system, an LTE time division duplex (TDD) system, a universal mobile telecommunications system (UMTS) system, a worldwide interoperability for microwave access (WiMAX) communication system, and a future 5th generation (5G) system or new radio (NR) system.

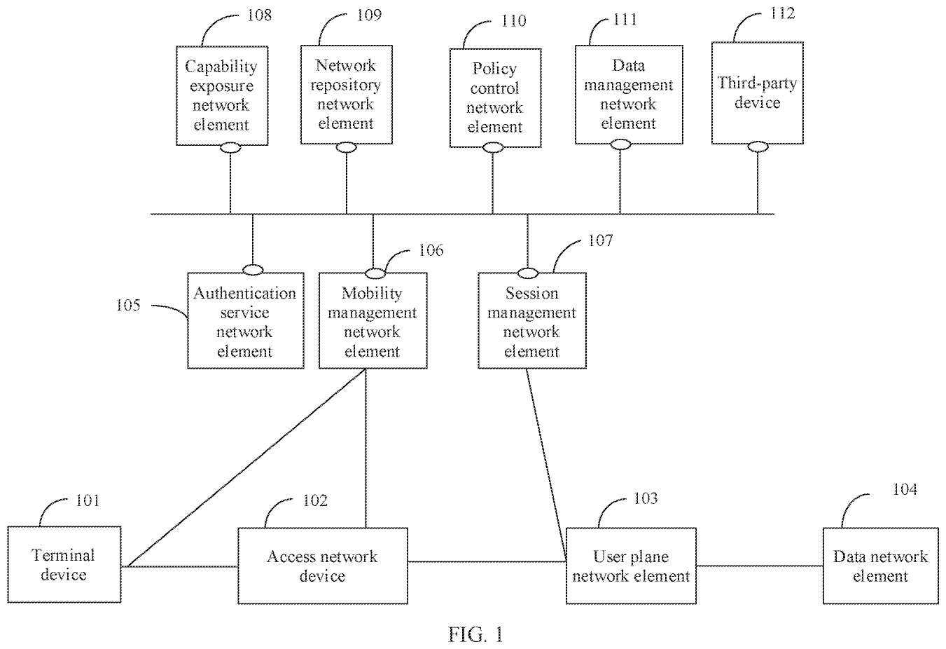

FIG. 1 is a schematic diagram of a possible network architecture to which this application is applicable. The network architecture includes a terminal device 101, an access network device 102, a user plane network element 103, a data network element 104, an authentication service network element 105, a mobility management network element 106, a session management network element 107, a capability exposure network element 108, a network repository network element 109, a policy control network element 110, a data management network element 111, and a third-party device 112, which are separately described below:

1. The terminal device (TD) 101 is referred to as a terminal for short, and is a device having a wireless transceiver function. The terminal device may include various handheld devices, vehicle-mounted devices, wearable devices, or computing devices that have a wireless communication function, or other processing devices connected to a wireless modem, and terminals in various forms, such as a mobile station (MS), a terminal, user equipment (UE), and a software client. The terminal may be deployed on land, including an indoor device, an outdoor device, a handheld device, or a vehicle-mounted device; or may be deployed on water (for example, on a ship), or may be deployed in the air (for example, on a plane, a balloon, or a satellite). For example, the terminal may be a mobile phone, a tablet computer (pad), a computer having a wireless transceiver function, a virtual reality (VR) terminal, an augmented reality (AR) terminal, a wireless terminal in industrial control, a wireless terminal in self-driving, a wireless terminal in telemedicine (remote medical), a wireless terminal in a smart grid, a wireless terminal in transportation safety, a wireless terminal in a smart city, or a wireless terminal in smart home.

2. The (radio) access network ((R)AN) device 102 is a device that provides a wireless communication function for a terminal, and includes but is not limited to a next-generation nodeB (g nodeB, gNB) in 5G, an evolved NodeB (eNB), a radio network controller (RNC), a NodeB (NB), a base station controller (BSC), a base transceiver station (BTS), a home base station (for example, home evolved nodeB, or home node B (HNB)), a baseband unit (BBU), a transmission reception point (TRP), a transmitting point (TP), and the like.

3. The user plane network element 103 is used for packet routing and forwarding, quality of service (QoS) processing of user plane data, and the like. In a 5G network, the user plane network element may be a user plane function (UPF) network element. In a future communication system, the user plane network element may still be the UPF network element, or may have another name. This is not limited in this application.

4. The data network element 104 is configured to provide a network for data transmission. In the 5G network, the data network element may be a data network (DN) element. In the future communication system, the data network element may still be the DN network element, or may have another name. This is not limited in this application.

5. The authentication service network element 105 is configured to implement user authentication, user authorization, and the like. In the 5G network, the authentication service network element may be an authentication server function (AUSF) network element. In the future communication system, the authentication service network element may still be the AUSF network element, or may have another name. This is not limited in this application.

6. The mobility management network element 106 is mainly configured to perform terminal access management and mobility management. In a 4G network, the mobility management network element may be a mobility management entity (MME). In the 5G network, the mobility management network element may be an access and mobility management function (AMF) network element. In the future communication system, the mobility management network element may still be the AMF network element, or may have another name. This is not limited in this application.

7. The session management network element 107 is mainly configured to manage a session, assign and manage an internet protocol (IP) address of a terminal device, select an endpoint that can manage a user plane function interface and a policy control and charging function interface, notify downlink data, and the like. In the 5G network, the session management network element may be a session management function (SMF) network element. In the future communication system, the session management network element may still be the SMF network element, or may have another name. This is not limited in this application.

8. The capability exposure network element 108 is configured to securely expose, to the outside, a service, a capability, and the like that are provided by a 3GPP network function network element. In the 4G network, the network exposure network element may be a service capability exposure function (SCEF) network element. In the 5G network, the network exposure network element may be a network exposure function (NEF) network element. In the future communication system, the network exposure network element may still be the NEF network element, or may have another name. This is not limited in this application.

9. The network repository network element 109 is configured to store information of a network function deployed in a core network, and provide discovery of a network function, a service, and the like. In the 5G network, the network repository network element may be a network repository function (NRF) network element. In the future communication system, the network repository network element may still be the NRF network element, or may have another name. This is not limited in this application.

10. The policy control network element 110 is configured to guide a unified policy framework of network behavior, provide policy rule information for a control plane function network element (such as an AMF or an SMF network element), and the like. In the 5G network, the policy control network element may be a policy control function (PCF) network element. In the future communication system, the policy control network element may still be the PCF network element, or may have another name, This is not limited in this application.

11. The data management network element 111 is configured to process a user identity, perform access authentication, registration, mobility management, and the like. In the 4G network, the data management network element may be a home subscriber server (HSS). In the 5G network, the data management network element may be a unified data management (UDM) network element. In the future communication system, the unified data management may still be the UDM network element, or may have another name, This is not limited in this application.

12. The third-party device 112 is a device configured to manage the terminal 101, and the third-party device 112 stores attribute information of the managed terminal, for example, location information and a type of the terminal. It should be noted that, an example in which the network architecture of this application includes one terminal 101 is used for illustration. In actual application, the network architecture may include a plurality of terminals. Correspondingly, the plurality of terminals may all be managed by the third-party device 112. Certainly, the plurality of terminals may also be managed by different third-party devices. Specifically, the third-party device 112 is connected to the capability exposure network element through an application interface provided by the capability exposure network element, and manages the terminal 101 by using the capability exposure network element, For example, the third-party device 112 may be a server device or an application function (AF) network element of a vertical industry control center.

It should be noted that the network elements in the embodiments of this application may also be referred to as functions or function entities, For example, the mobility management network element 106 may also be referred to as a mobility management function or a mobility management function entity, and the data management network element may also be referred to as a data management function or a data management function entity. The name of each network element is not limited in this application. A person skilled in the art may change the names of the foregoing network elements to other names to perform the same functions. This falls within the protection scope of this application.

It may be understood that the foregoing network elements or functions may be network elements in a hardware device, may be software functions running on dedicated hardware, or may be virtualized functions instantiated on a platform (for example, a cloud platform).

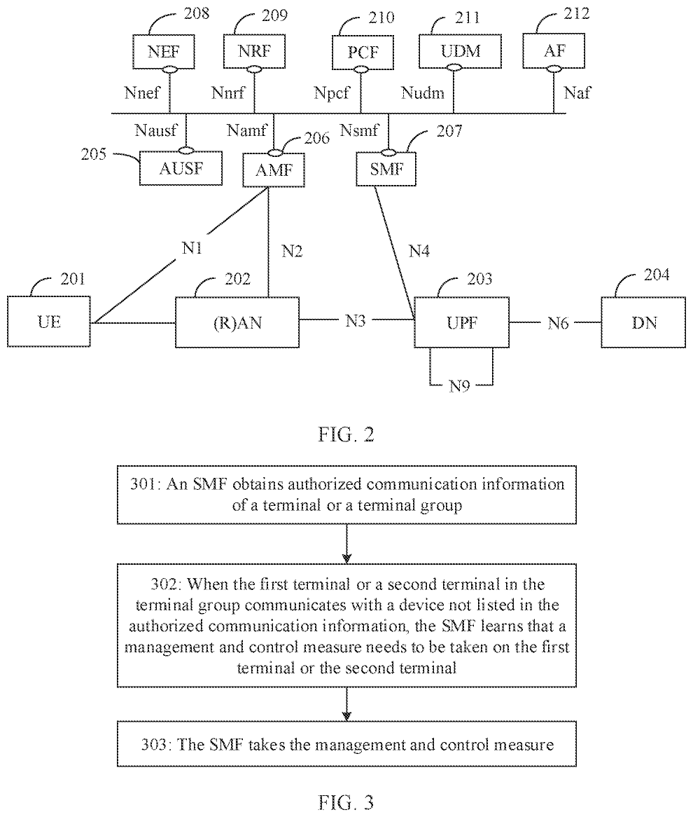

FIG. 2 is a schematic diagram of another possible network architecture to which this application is applicable. In FIG. 2, a 5G network architecture is used as an example. The network architecture includes: a terminal device 101, a (R)AN 202, a UPF network element 203, a DN network element 204, an AUSF network element 205, an AMF network element 206, an SMF network element 207, an NEF network element 208, an NRF network element 209, a PCF network element 210, a UDM network element 211, and an AF network element 212, The UPF network element 203, the DN network element 204, the AUSF network element 205, the AMF network element 206, the SMF network element 207, the NEF network element 208, the NRF network element 209, the PCF network element 210, the UDM network element 211, and the AF network element 212 are briefly referred to as the UPF 203, the DN 204, the AUSF 205, the AMF 206, the SMF 207, the NET 208, the NRF 209, the PCF 210, the UDM 211, and the AF 212 below, The access network device in the network architecture shown in FIG. 1 may be the (R)AN 202 in the network architecture shown in FIG. 2. The user plane network element 103 in the network architecture shown in FIG. 1 may be the UPF 203 in the network architecture shown in FIG. 2. The data network element 104 in the network architecture shown in FIG. 1 may be the DN 204 in the network architecture shown in FIG. 2, The authentication service network element 105 in the network architecture shown in FIG. 1 may be the AUSF 205 in the network architecture shown in FIG. 2. The mobility management network element 106 in the network architecture shown in FIG. 1 may be the AMF 206 in the network architecture shown in FIG. 2. The session management network element 107 in the network architecture shown in FIG. 1 may be the SMF 207 in the network architecture shown in FIG. 2. The capability exposure network element 108 in the network architecture shown in FIG. 1 may be the NEF 208 in the network architecture shown in FIG. 2. The network repository network element 109 in the network architecture shown in FIG. 1 may be the NRF 209 in the network architecture shown in FIG. 2. The policy control network element 110 in the network architecture shown in FIG. 1 may be the PCF 210 in the network architecture shown in FIG. 2. The data management network element 111 in the network architecture shown in FIG. 1 may be the UDM 211 in the network architecture shown in FIG. 2. The third-party device 112 in the network architecture shown in FIG. 1 may be the AF 212 in the network architecture shown in FIG. 2. For a function of each network element, refer to the description in FIG. 1. Details are not described herein again.

In the network architecture, Nausf is a service-based interface presented by the AUSF 205, Namf is a service-based interface presented by the AMF 206, Nsmf is a service-based interface presented by the SMF 207, Nnef is a service-based interface presented by the NEF 208, Nnrf is a service-based interface presented by the NRF 209, Npcf is a service-based interface presented by the PCF 210, Nudm is a service-based interface presented by the UDM 211, and Naf is a service-based interface presented by the AF 212. N1 is a reference point between the UE 201 and the AMF 206. N2 is a reference point between the (R)AN 202 and the AMF 206, and is configured to send a non-access stratum (NAS) message and the like. N3 is a reference point between the (R)AN 202 and the UPF 203, and is configured to transmit user plane data and the like. N4 is a reference point between the SMF 207 and the UPF 203, and is configured to transmit information such as tunnel identifier information, data buffer indication information, and a downlink data notification message of an N3 connection. The N6 interface is a reference point between the UPF 203 and the DN 204, and is configured to transmit user plane data and the like.

It should be understood that the foregoing network architecture applied to this embodiment of this application is merely an example of a network architecture described from a perspective of a service architecture, and a network architecture applicable to this embodiment of this application is not limited thereto. Any network architecture that can implement functions of the foregoing network elements is applicable to this embodiment of this application.

The following describes, by using the network architecture shown in FIG. 2 as an example, a terminal monitoring method provided in the embodiments of this application. In other words, an example in which the session management network element is an SMF, the policy control network element is a PCF, the data management network element is a UDM, the capability exposure network element is an NEF, and the user plane network element is a UPF is used for description.

FIG. 3 shows a terminal management and control method provided in an embodiment of this application. The method includes the following steps.

S301: An SMF obtains authorized communication information of a terminal (for example, a first terminal) or a terminal group.

When the SMF obtains the authorized communication information of the first terminal, the authorized communication information includes an identifier of the first terminal and information about a device with which the first terminal is allowed to communicate. The information about the device with which the first terminal is allowed to communicate may be, for example, one or more of an identifier (ID), an internee protocol (IP) address, a media access control (MAC) address, an application identifier or an application server network address of the device with which the first terminal is allowed to communicate. It may be understood that the authorized communication information may include a list of information about devices with which the first terminal is allowed to communicate, and the list of the information about the devices with which the first terminal is allowed to communicate may be, for example, one or more of a list of identifiers, a list of IP addresses, a list of MAC addresses, a list of application identifiers, or a list of application server network addresses of the devices with which the first terminal is allowed to communicate.

When the SMF obtains the authorized communication information of the terminal group, the authorized communication information includes a terminal group identifier (group ID) and information about a device with which the terminal group is allowed to communicate. The information about the device with which the terminal group is allowed to communicate may be, for example, one or more of an identifier, an IP address, a MAC address, an application identifier, or an application server network address of the device with which the terminal group is allowed to communicate. It may be understood that the authorized communication information may include a list of information about devices with which the terminal group is allowed to communicate, and the list of the information about the devices with which the terminal group is allowed to communicate may be, for example, one or more of a list of identifiers, a list of IP addresses, a list of MAC addresses, a list of application identifiers, or a list of application server network addresses of the devices with which the terminal group is allowed to communicate.

How the SMF obtains the authorized communication information of the first terminal or the: terminal group is not limited in this embodiment of this application. The following describes two methods for the SMF to obtain the authorized communication information of the first terminal or the terminal group.

Method 1: A PCF sends the authorized communication information of the first terminal or the terminal group to the SMF, so that the SMF receives the authorized communication information that is of the first terminal or the terminal group and that is from the PCF. For example, the PCF generates a session management policy (SM policy) based on the authorized communication information, and sends the authorized communication information to the SMF by using an SM policy control update notification (Npcf_SM policy control_update notify) message. Certainly, the PCF may alternatively send the authorized communication information to the SMF by using another message or a new message. This is not limited in this application.

Method 2: The SMF locally obtains the authorized communication information based on the identifier of the first terminal or the identifier of the terminal group. The authorized communication information locally stored in the SMF may be preconfigured by the PCF for the SMF by using the SM policy control update notification message. Certainly, the authorized communication information locally stored in the SMF may alternatively be preconfigured by the PCF for the SMF by using another message or a new message. This is not limited in this application.

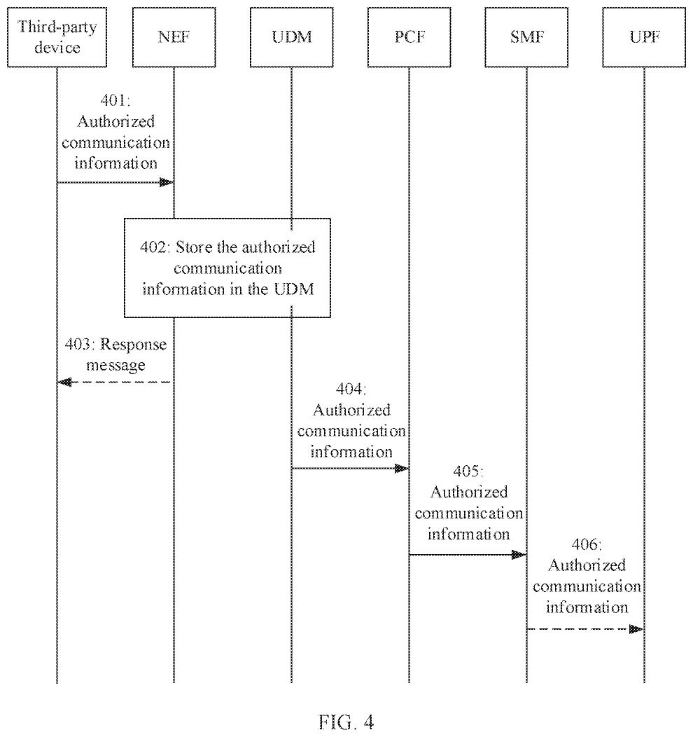

For details about how the PCF sends the authorized communication information to the SMF by using the SM policy control update notification message in Method 1. and Method 2, refer to the embodiment shown in FIG. 4. Details are not described herein again.

In an example, the SMF further obtains indication information. The SMF may obtain the indication information when obtaining the authorized communication information. The indication information is used to indicate that a management and control measure is taken when the first terminal or a second terminal communicates with a device not listed in the authorized communication information. For details about the management and control measure, refer to S302 below.

S302: When the first terminal or the second terminal in the terminal group communicates with the device not listed in the authorized communication information, the SMF learns that the management and control measure needs to be taken on communication of the first terminal or the second terminal.

The management and control measure is specific to the communication of the first terminal or the second terminal. The communication of the first terminal or the second terminal specifically refers to a behavior that the first terminal or the second terminal accesses another device (that is, sends data) or accepts access (that is, receives data) of another device. The management and control measure may specifically include any one or more of the following: performing packet discarding processing on data; when a quantity of times that the first terminal or the second terminal in the terminal group communicates with the device not listed in the authorized communication information exceeds a preset value, performing the packet discarding processing on the data; performing reporting to a third-party device; when the quantity of times that the first terminal or the second terminal in the terminal group communicates with the device not listed in the authorized communication information exceeds the preset value, performing the reporting to the third-party device. The data is data exchanged by the first terminal or the second terminal with the device not listed in the authorized communication information, and the third-party device manages the first terminal or the terminal group. The SMF may obtain the preset value when obtaining the authorized communication information.

How the SMF learns that the management and control measure needs to be taken on the first terminal or the second terminal is not limited in this embodiment of this application, The following describes three methods for the SMF to learn that the management and control measure needs to be taken on the first terminal or the second terminal.

Method 1: A UPF detects that the first terminal or the second terminal communicates with the device not listed in the authorized communication information, and reports report information to the SMF, so that the SMF receives the report information from the UPF.

The UPF detects that the first terminal or the second terminal communicates with the device not listed in the authorized communication information, and generates the report information, where the report information is used to indicate that the first terminal or the second terminal communicates with the device not listed in the authorized communication information, and includes exception event description information and the identifier of the first terminal or an identifier of the second terminal. Optionally, the report information further includes any one or more of location information of the first terminal or the second terminal, information of the device not listed in the authorized communication information (for example, an IP address, a MAC address, an application identifier, or an application server network address of the device not listed in the authorized communication information), a type of the first terminal or the second terminal, or a reference point session identifier (for example, an N4 session ID), The exception event description information is, for example, information indicating that the first terminal or the second terminal communicates with the device not listed in the authorized communication information. Optionally, the exception event description information further includes a quantity of times that the exception event occurs. When the report information indicates that the second terminal communicates with the device not listed in the authorized communication information, the report information may further include an identifier of a group in which the second terminal is located.

Specifically, the UPF detects data exchanged by the first terminal or the second terminal with the device not listed in the authorized communication information, matches the data with the authorized communication information, and finds that the data carries information about the device not listed in the authorized communication information, for example, an identifier, an IP address, a MAC address, an application identifier, or an application server network address of the device not listed in the authorized communication information, to detect that the first terminal or the second terminal communicates with the device not listed in the authorized communication information. When the UPF detects that the second terminal communicates with the device not listed in the authorized communication information, the UPF further determines the authorized communication information of the terminal group based on an identifier that is of the terminal group and that is carried in the data,

In an example of Method 1, if the SMF receives the indication information in S301, after receiving the report information from the UPF, the SMF learns, based on the indication information, that the management and control measure needs to be taken on the first terminal or the second terminal.

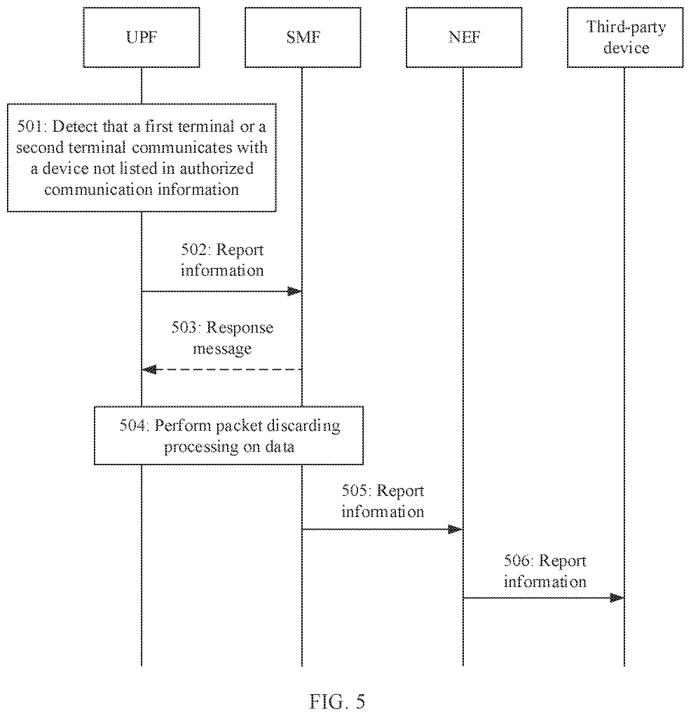

For other content, refer to the embodiment shown in FIG. 5. Details are not described herein again.

Method 2: A UPF detects that the first terminal or the second terminal communicates with the device not listed in the authorized communication information, and sends a management and control request to the SMF, so that the SMF receives the management and control request from the UPF. The management and control request is used to indicate that the management and control measure needs to be taken on the first terminal or the second terminal. Specifically, for details about how the UPF detects that the first terminal or the second terminal communicates with the device not listed in the authorized communication information, refer to the description in Method 1.

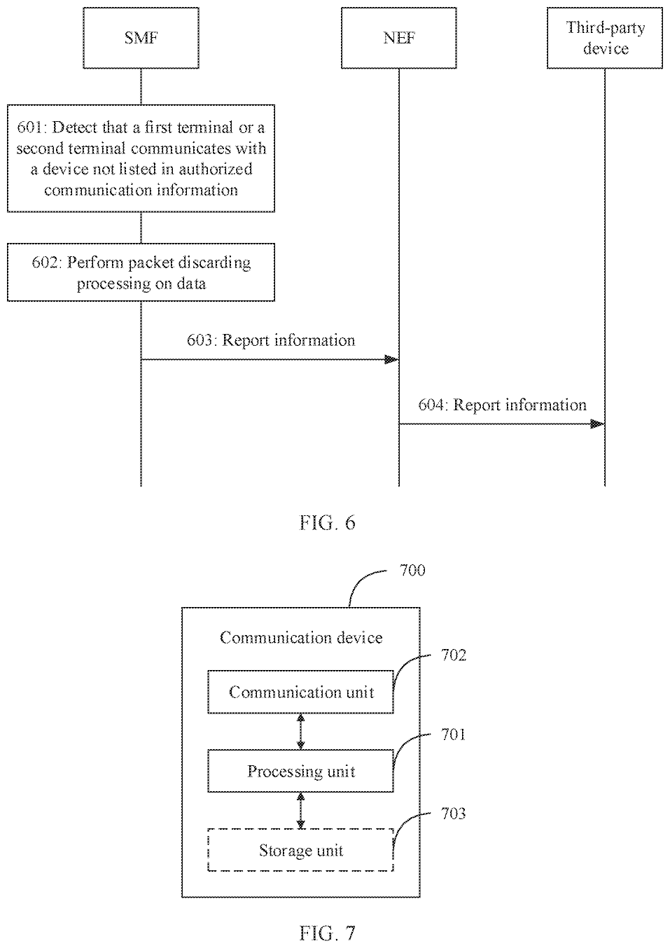

Method 3: The SMF detects that the first terminal or the second terminal communicates with the device not listed in the authorized communication information. For details, refer to the embodiment shown in FIG. 6. Details are not described herein again.

Specifically, the SMF detects data exchanged by the first terminal or the second terminal with the device not listed in the authorized communication information, matches device information carried in the data with the authorized communication information, and finds that the data carries information about the device not listed in the authorized communication information, for example, an identifier, an IP address, a MAC address, an application identifier, or an application server network address of the device not listed in the authorized communication information, to detect that the first terminal or the second terminal communicates with the device not listed in the authorized communication information. When the SMF detects that the second terminal communicates with the device not listed in the authorized communication information, the SMF further determines the authorized communication information of the terminal group based on an identifier that is of the terminal group and that is carried in the data.

In an example of Method 3, if the SMF receives the indication information in S301, after detecting that the first terminal or the second terminal communicates with the device not listed in the authorized communication information, the SMF learns, based on the indication information, that the management and control measure needs to be taken on the first terminal or the second terminal.

S303: The SMF takes the management and control measure.

If the management and control measure includes performing the packet discarding processing on the data (including performing the packet discarding processing on the data for more than the preset quantity of times), the data is data exchanged by the first terminal or the second terminal with the device not listed in the authorized communication information.

How the SMF performs the packet discarding processing on the data is not limited in this embodiment of this application. The following describes two methods for the SMF to perform the packet discarding processing on the data.

Method 1: After receiving the report information or the management and control request from the UPF, the SMF instructs the UPF to delete the data exchanged by the first terminal or the second terminal with the device not listed in the authorized communication information. After receiving the notification from the SMF, the UPF deletes the data.

It should be noted that Method 1 corresponds to Method 1 and Method 2 by using what the SMF learns that the management and control measure needs to be taken on the first terminal or the second terminal in S302.

Method 2: The SMF deletes the data exchanged by the first terminal or the second terminal with the device not listed in the authorized communication information.

It should be noted that Method 2 corresponds to Method 3 by using what the SMF learns that the management and control measure needs to be taken on the first terminal or the second terminal in S302.

If the management and control measure includes performing the reporting to the third-party device including performing the reporting to the third-party device for more than the preset quantity of times), how the SMF performs the reporting to the third-party device is not limited in this embodiment of this application. The following describes two methods for the SMF to perform the packet discarding processing on the data.

Method 1: The SMF forwards the report information received from the UPF, to the third-party device. Specifically, the SMF sends the report information to an NEF, and the NEF forwards the report information to the third-party device.

It should be noted that Method 1 corresponds to Method 1 by using which the SMF learns that the management and control measure needs to be taken on the first terminal or the second terminal in S302.

For other content, refer to the embodiment shown in FIG. 5. Details are not described herein again.

Method 2: The SMF generates the report information and sends the report information to the third-party device. Specifically, the SMF sends the report information to an NEF, and the NEF forwards the report information to the third-party device.

It should be noted that Method 1 corresponds to Method 2 and Method 3 by using which the SMF learns that the management and control measure needs to be taken on the first terminal or the second terminal in S302.

For other content, refer to the embodiment shown in FIG. 6. Details are not described herein again.

According to the foregoing methods, the SMF obtains the authorized communication information of the first terminal or the terminal group, and when the first terminal or the second terminal in the terminal group communicates with the device not listed in the authorized communication information, the SMF learns that the management and control measure needs to be taken on the first terminal or the second terminal in the terminal group. According to the method, a terminal communicates with a device listed in the authorized communication information, and a communication behavior of the terminal is managed and monitored, thereby ensuring stability and security of terminal communication.

Based on the embodiment in FIG. 3. FIG. 4 provides a terminal management and control method, so that an SMF and a UPF obtain authorized communication information of a first terminal or a terminal group. The method includes the following steps.

S401: A third-party device provides, for an NEF, the authorized communication information that is of the first terminal or the terminal group and that needs to be configured, so that the NEF receives the authorized communication information that is of the first terminal or the terminal group and that is from the third-party device.

For a description of the authorized communication information, refer to S301. Details are not described herein again.

In an example, the third-party device further provides indication information for the NEF. Specifically, the indication information may include a first indication (action 1) and/or a second indication (action 2). The first indication is used to indicate that packet discarding processing is performed on data when the first terminal or a second terminal in the terminal group communicates with a device not listed in the authorized communication information, and the second indication is used to indicate that reporting is performed to the third-party device when the first terminal or the second terminal in the terminal group communicates with the device not listed in the authorized communication information. It should be noted that the first indication and the second indication may be the same indication, that is, one indication may be used to indicate that the packet discarding processing is performed on the data when the first terminal or the second terminal in the terminal group communicates with the device not listed in the authorized communication information, and may also be used to indicate that the reporting is performed to the third-party device when the first terminal or the second terminal in the terminal group communicates with the device not listed in the authorized communication information. The first indication and the second indication in the following may also be the same indication. A general description is provided herein, and details are not described below

In an example, the third-party device provides the authorized communication information of the first terminal or the terminal group for the NEF by using a specified parameter update request (Nnef_parameter provision_update request) message.

S402: The NEF stores, in a UDM, the authorized communication information that is of the first terminal or the terminal group and that needs to be configured.

In an example, the authorized communication information of the first terminal or the terminal group is stored in the UDM as a part of user subscription data or user group subscription data.

In an example, the NEF further stores the indication information in the UDM, or stores the indication information in the UDM as a part of the user subscription data or the user group subscription data. Specifically, the indication information may include the first indication and/or the second indication.

Further, the UDM may store the authorized communication information of the first terminal or the terminal group in the UDR.

S403: Optionally, the NEF returns a response message to the third-party device.

The response message is used to reply the third-party device, to indicate that the operation of configuring the authorized communication information is completed.

In an example, the NEF returns the response message to the third-party device by using a specified parameter update response (Nnef_parameter provision_update request response) message.

S404: The UDM sends the authorized communication information of the first terminal or the terminal group to a PCF, so that the PCF receives the authorized communication information that is of the first terminal or the terminal group and that is from the UDM.

In an example, the UDM uses the authorized communication information of the first terminal or the terminal group as the user subscription data or the user group subscription data of the first terminal, and sends the authorized communication information of the first terminal or the terminal group to the PCF.

In an example, the UDM further sends the indication information to the PCF, or uses the indication information as the user subscription data or the user group subscription data of the first terminal and sends the indication information to the PCF. Specifically, the indication information may include the first indication and/or the second indication.

In an example, the UDM sends the authorized communication information of the first terminal or the terminal group to the PCF by using a service operation getting (Nudm_SDM_get service operation) message.

S405: The PCF sends the authorized communication information of the first terminal or the terminal group to the SMF, so that the SMF receives the authorized communication information that is of the first terminal or the terminal group and that is from the PCF.

In an example, the PCF generates a session management policy (SM policy) based on the authorized communication information of the first terminal or the terminal group, and sends the SM policy to the SMF The SM policy includes the authorized communication information of the first terminal or the terminal group.

In the foregoing example, the PCF further generates the SM policy based on the indication information, and sends the SM policy to the SMF. The SM policy includes the authorized communication information and the indication information of the first terminal or the terminal group.

In an example, the PCF sends the authorized communication information to the SMF by using an SM policy control update notification (Npcf_SM policy control_update notify) message.

In an example, the SMF stores the authorized communication information of the first terminal or the terminal group, and optionally, further stores the indication information. The indication information may include the first indication and/or the second indication.

S406. Optionally, the SMF sends the authorized communication information of the first terminal or the terminal group to the UPF, so that the UPF receives the authorized communication information that is of the first terminal or the terminal group and that is from the SMF.

In an example, the SMF sends the SM policy to the UPF.

In an example, the UPF stores the authorized communication information of the first terminal or the terminal group, and optionally, further stores the indication information, The indication information may include the first indication and/or the second indication.

According to the foregoing method, the third-party device provides the authorized communication information of the first terminal or the terminal group, so that the SMF and the UPF obtain the information about the device with which the first terminal or the terminal in the terminal group is allowed to communicate, and subsequently, when the first terminal or the second terminal communicates with the device not listed in the authorized communication information, the management and control measure can be taken.

Based on the embodiments in FIG. 3 and FIG. 4 FIG. 5 provides a terminal management and control method. In this method, a UPF detects that a first terminal or a second terminal communicates with a device not listed in authorized communication information, so that the UPF and an SMF perform packet discarding processing on data and perform reporting to a third-party device. The method includes the following steps

S501: The UPF detects that a first terminal or a second terminal communicates with a device not listed in the authorized communication information.

Specifically, when receiving uplink data from the first terminal or the second terminal, the UPF matches device information carried in the uplink data with the authorized communication information, and finds that the uplink data carries information about a device not listed in the authorized communication information, for example, an identifier, an IP address, a MAC address, an application identifier, or an application server network address of the device not listed in the authorized communication information, to detect that the first terminal or the second terminal accesses the device not listed in the authorized communication information. When the UPF detects that the second terminal accesses the device not listed in the authorized communication information, the uplink data further carries an identifier of a terminal group, and the UPF determines authorized communication information of the terminal group based on the identifier of the terminal group.

When receiving downlink data sent by a device to the first terminal or the second terminal, the UPF matches device information carried in the downlink data with the authorized communication information, and finds that the downlink data carries information about the device not listed in the authorized communication information, for example, an identifier, an IP address, a MAC address, an application identifier, or an application server network address of the device not listed in the authorized communication information, to detect that the first terminal or the second terminal accepts access of the device not listed in the authorized communication information. When the UPF detects that the second terminal accepts access of the device not listed in the authorized communication information, the downlink data further carries the identifier of the terminal group, and the UPF determines the authorized communication information of the terminal group based on the identifier of the terminal group.

S502: The UPF reports the report information to the SMF, so that the SMF receives the report information from the UPF.

The report information is used to indicate that the first terminal or the second terminal communicates with the device not, listed in the authorized communication information. For the report information, refer to the description in Method 1 in S302. Details are not described herein again.

In an example, the UPF performs reporting to the third-party device based on a second indication. Specifically, the UPF sends the report information to the SMF based on the second indication, the SMF sends the report information to the NEF based on the second indication, and the NEF forwards the report information to the third-party device.

In an example, the UPF reports the report information to the SMF by using a session event report message.

S503: Optionally, the SMF acknowledges the report information to the UPF, and returns a response message to the UPF so that the UPF receives the response message from the SMF.

In an example, the SMF acknowledges the report information to the UPF by using a session event response message.

S504: After determining the report information, the SMF performs the packet discarding processing on the data, where the data is data exchanged by the first terminal or the second terminal with the device not listed in the authorized communication information.

Specifically, the SMF sends a notification to the UPF. After receiving the notification from the SMF, the UPF deletes the data exchanged by the first terminal or the second terminal with the device not listed in the authorized communication information.

It should be noted that, in this scenario of this embodiment in this application, performing the packet discarding processing on the data includes that the SMF instructs the UPF to delete the data exchanged by the first terminal or the second terminal with the device not listed in the authorized communication information and that the UPF deletes the data.

In an example, the SMF performs the packet discarding processing on the data based on a first indication.

S505: The SMF sends the report information to the NEF, so that the NEF receives the report information from the SMF.

In an example, the SMF reports the report information to the third-party device based on the second indication.

In an example, the SMF sends the report information to the NEF by using an event report (Nsmf_event_report) message.

S506: The NEF sends the report information to the third-party device, so that the third-party device receives the report information from the NEF.

In an example, the NEF sends the report information to the third-party device by using the event report (Nnef_event_report) message.

According to the foregoing method, the UPF detects that the first terminal or the second terminal communicates with the device not listed in the authorized communication information. Further, the SMF and the UPF perform the packet discarding processing on exceptional data, and report the exception to the third-party device. According to the method, the terminal communicates with a device listed in the authorized communication information, so that a communication behavior of the terminal is managed and monitored. After learning the exception, the third-party device takes a corresponding measure (for example, returning the terminal to a factory for maintenance), thereby ensuring stability and security of terminal communication.

Based on the embodiments in FIG. 3 and FIG. 4, FIG. 6 provides a terminal management and control method. In this method, an SMF detects that a first terminal or a second terminal communicates with a device not listed in authorized communication information, performs packet discarding processing on data, and performs reporting to a third-party device.

First, it should be noted that in this method, data is transmitted by using control plane non-access stratum (NAS) signaling. A transmission path of uplink data is specifically: data uploaded by a terminal is transmitted to an AMF by using a RAN, then transmitted to an NEF by using the SMF, and finally transmitted to the third-party device by using the NEF. The method may be specifically applied to an internet of things scenario. According to service requirements of the internet of things industry, a small amount of data is sent or received by the terminal. The small amount of data packets may be sent or received by using control plane NAS signaling, so that establishment of a packet data unit session (PDU session) is avoided, thereby saving resources and shortening a communication response time. A transmission path of downlink data transmission is specifically: the data delivered to the terminal is transmitted to the NEF by using the third-party device, and then is transmitted to the SMF by using the NEF.

As shown in FIG. 6, the method includes the following steps.

S601: The SMF detects that a first terminal or a second terminal communicates with a device not listed in authorized communication information.

Specifically, when receiving uplink data from the first terminal or the second terminal, the SMF matches device information carried in the uplink data with the authorized communication information, and finds that the uplink data carries information about the device not listed in the authorized communication information, for example, an identifier, an IP address, a MAC address, an application identifier, or an application server network address of the device not listed in the authorized communication information, to detect that the first terminal or the second terminal accesses the device not listed in the authorized communication information. When the SMF detects that the second terminal accesses the device not listed in the authorized communication information, the uplink data further carries an identifier of a terminal group, and the SMF determines authorized communication information of the terminal group based on the identifier of the terminal group.

When receiving downlink data sent by a device to the first terminal or the second terminal, the SMF matches device information carried in the downlink data with the authorized communication information, and finds that the downlink data carries information about the device not listed in the authorized communication information, for example, an identifier, an IP address, a MAC address, an application identifier, or an application server network address of the device not listed in the authorized communication information, to detect that the first terminal or the second terminal accepts access of the device not listed in the authorized communication information. When the SMF detects that the second terminal accepts access of the device not listed in the authorized communication information, the downlink data further carries the identifier of the terminal group, and a UPF determines the authorized communication information of the terminal group based on the identifier of the terminal group.

S602: The SMF performs packet discarding processing on data, where the data is data exchanged by the first terminal or the second terminal with the device not listed in the authorized communication information.

Specifically, the SMF deletes the data exchanged by the first terminal or the second terminal with the device not listed in the authorized communication information.

In an example, the SMF performs the packet discarding processing on the data based on a first indication.

S603: The SMF sends report information to the NEE so that the NEF receives the report information from the SMF. For details, refer to the description in S505. Details are not described again.

The report information is used to indicate that the first terminal or the second terminal communicates with the device not listed in the authorized communication information. For the report information, refer to the description in Method 1 in S302. Details are not described herein again.

S604: The NEF sends the report information to the third-party device, so that the third-party device receives the report information from the NEF. For details, refer to the description in S506. Details are not described again.

According to the foregoing method, the SMF detects that the first terminal or the second terminal communicates with the device not listed in the authorized communication information, further performs the packet discarding processing on exceptional data, and reports the exception to the third-party device. According to the method, the terminal communicates with a device listed in the authorized communication information, so that a communication behavior of the terminal is managed and monitored. After learning the exception, the third-party device takes a corresponding measure (for example, returning the terminal to a factory for maintenance), thereby ensuring stability and security of terminal communication.

The foregoing mainly describes the solutions provided in the embodiments of this application from a perspective of interaction between network elements. It may be understood that, to implement the foregoing functions, the session management network element, the user plane network element, or the third-party device includes corresponding hardware structures and/or software modules for performing the functions, A person skilled in the art should be easily aware that, in combination with the examples of units and algorithm steps described in the embodiments disclosed in this specification, this application can be implemented by hardware or a combination of hardware and computer software, Whether a function is performed by hardware or hardware driven by computer software depends on particular applications and design constraints of the technical solutions. A person skilled in the art may use different methods to implement the described functions of each particular application, but it should not be considered that the implementation goes beyond the scope of this application.

In the embodiments of this application, the session management network element, the user plane network element, and the third-party device may be divided into functional modules based on the foregoing method examples. For example, functional modules corresponding to functions may be obtained through division, or two or more functions may be integrated into one processing module. The integrated module may be implemented in a form of hardware, or may be implemented in a form of a software functional module. It should be noted that, in the embodiments of this application, module division is an example, and is merely logical function division. In actual implementation, another division manner may be used.

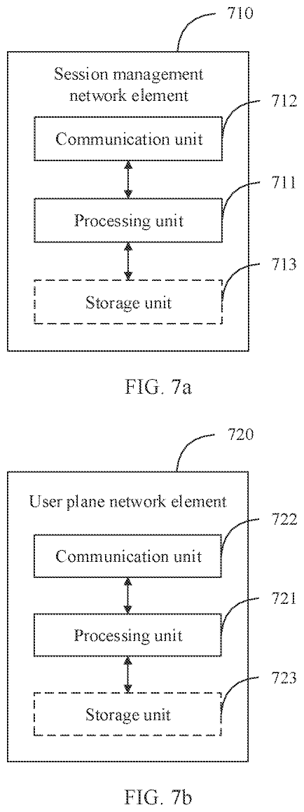

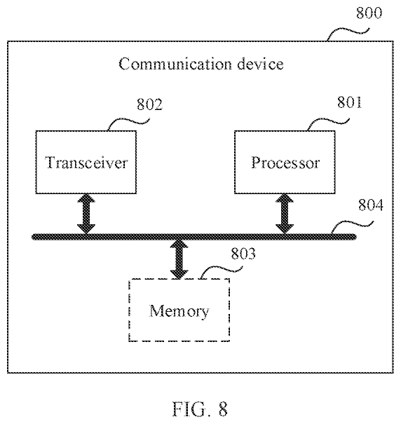

For example, the foregoing network elements or functions may be implemented by using a communication device in FIG. 7. As shown in FIG. 7, the communication device 700 may be a session management network element, a user plane network element, or a third-party device. The communication device includes a processing unit 701 and a communication unit 702, and optionally, further includes a storage unit 703. Further, the communication unit 702 may be divided into a receiving unit and a sending unit which respectively implement functions of receiving information and sending information.

The processing unit 701 is configured to control actions of the foregoing network elements, for example, support the foregoing network elements in performing the methods and the steps provided in the embodiments of this application. The communication unit 702 is configured to support the network elements in sending information to another network entity, for example, a step in which the network elements send information to another network entity in the embodiments of this application. The receiving unit 703 is configured to support the network elements in receiving information sent by another network entity, for example, a step in which the network elements receive information sent by another network entity in the embodiments of this application. The storage unit 703 is configured to store data and code of the foregoing network elements.

The communication device 700 may be a session management network element. FIG. 7a is a schematic structural diagram of a session management network element 710. The session management network element includes a processing unit 711 and a communication unit 712, and optionally, further includes a storage unit 713.

In an embodiment, the session management network element 710 may be configured to perform operations of the session management network element in the foregoing method embodiments. Examples are as follows:

The processing unit 711 is configured to obtain authorized communication information of a first terminal or a terminal group by using the communication unit 712, where the authorized communication information includes information about a device with which the first terminal or the terminal group is allowed to communicate. For details, refer to S301 in FIG. 3.

When the first terminal or a second terminal in the terminal group communicates with a device not listed in the authorized communication information, the processing unit learns that a management and control measure needs to be taken on communication of the first terminal or the second terminal. For details, refer to S302 in FIG. 3.

The processing unit implements the management and control measure. For details, refer to S303 in FIG. 3.

Further, the session management network element may be configured to perform corresponding steps in FIG. 3, FIG. 4, FIG. 5, or FIG. 6. For details, refer to the descriptions in the foregoing method embodiments. Examples are as follows:

The processing unit 711 may be configured to perform S504, S601, and S602. For details, refer to the descriptions in the foregoing steps.

The communication unit 712 may be configured to perform S405, S406, S502, S503, S505, and S603. For details, refer to the descriptions in the foregoing steps.

The communication apparatus 700 may alternatively be a user plane network element. FIG. 7b is a schematic structural diagram of a user plane network element 720, The user plane network element includes a processing unit 721 and a communication unit 722, and optionally, further includes a storage unit 723.

In an embodiment, the user plane network element 720 may be configured to perform operations of the user plane network element in the foregoing method embodiments. Examples are as follows:

The processing unit 721 is configured to obtain authorized communication information of a first terminal or a terminal group by using the communication unit 722, where the authorized communication information includes information about a device with which the first terminal or the terminal group is allowed to communicate. For details, refer to S406 in FIG. 4.

The processing unit detects that the first terminal or a second terminal in the terminal group communicates with a device not listed in the authorized communication information. For details, refer to S501 in FIG. 5.

The processing unit takes a management and control measure on communication of the first terminal or the second terminal. For details, refer to S502 and S504 in FIG. 5.

Further, the user plane network element may be configured to perform corresponding steps in FIG. 3, FIG. 4, FIG. 5, or FIG. 6. For details, refer to the descriptions in the foregoing method embodiments. Examples are as follows:

The processing unit 721 may be configured to perform S504. For details, refer to the descriptions in the foregoing steps.

The communication unit 722 may be configured to perform S502, S503, and S504. For details, refer to the descriptions in the foregoing steps.

When the processing unit 701, 711, or 721 may be one or more processors, the communication unit 702, 712, or 722 may be one or more transceivers, and the storage unit 703, 713, or 723 may be one or more memories, the session management network element, the user plane network element, or the third-party device in the embodiments of this application may have a structure shown in FIG. 8.

Referring to FIG. 8, the communication device 800 includes a processor 801 and a transceiver 802. Optionally, the communication device 800 may include a memory 803 and a bus 804. The processor 801, the transceiver 802, and the memory 803 are connected by using the bus 804. For example, the processor 801 may be a central processing unit (CPU), a general-purpose processor, a digital signal processor (DSP), an application-specific integrated circuit (ASIC), a field programmable gate array (FPGA) or another programmable logic device, a transistor logic device, a hardware component, or any combination thereof. The processor may implement or execute various example logical blocks, modules, and circuits described with reference to this application. Alternatively, the processor may be a combination of processors implementing a computing function, for example, a combination of one or more microprocessors, or a combination of a DSP and a microprocessor. The bus 804 may be a peripheral component interconnect (PCI) bus, an extended industry standard architecture (EISA) bus, or the like. The bus may be classified into an address bus, a data bus, a control bus, and the like. For ease of representation, only one thick line is used to represent the bus in FIG. 8, but this does not mean that there is only one bus or only one type of bus.

An embodiment of this application further provides a chip system 900, including at least one processor 901 and an interface circuit 902, where the processor 901 is connected to the interface circuit 902.

The processor 901 may be an integrated circuit chip and has a signal processing capability. In an implementation process, steps in the foregoing methods can be implemented by a hardware integrated logical circuit in the processor 901, or by instructions in a form of software. The processor 901 may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor may implement or perform the methods and steps that are disclosed in the embodiments of this application. The general-purpose processor may be a microprocessor, or the processor may be any conventional processor or the like.

The interface circuit 902 may send or receive data, instructions, or information. The processor 901 may process data, instructions, or other information received through the interface circuit 902, and send, through the interface circuit 902, information obtained after processing.

Optionally, the chip system further includes a memory 903. The memory 903 may include a read-only memory and a random access memory, and provide operation instructions and data for the processor. Apart of the memory 903 may further include a non-volatile random access memory (NVRAM).

Optionally, the memory 903 stores an executable software module or a data structure, and the processor 901 may perform a corresponding operation by invoking an operation instruction stored in the memory (the operation instruction may be stored in an operating system).

Optionally, the chip system may be used in the session management network element, the user plane network element, or the third-party device in the embodiments of this application. Optionally, the interface circuit 902 is configured to perform receiving and sending steps of the session management network element, the user plane network element, or the third-party device in the embodiments shown in FIG. 3 to FIG. 6. The processor 901 is configured to perform processing steps of the session management network element, the user plane network element, or the third-party device in the embodiments shown in FIG. 3 to FIG. 6. The memory 903 is configured to store data and instructions of the session management network element, the user plane network element, or the third-party device in the embodiments shown in FIG. 3 to FIG. 6.

An embodiment of this application further provides a computer-readable storage medium. All or some of the methods described in the foregoing method embodiments may be implemented by using software, hardware, firmware, or any combination thereof If the methods are implemented in software, functions used as one or more instructions or code may be stored in or transmitted on the computer-readable medium. The computer-readable medium may include a computer storage medium and a communication medium, and may further include any medium that can transfer a computer program from one place to another. The storage medium may be any available medium accessible to a computer.

In an optional design, the computer readable medium may include a RAM, a ROM, an EEPROM, a CD-ROM or another optical disc storage, a magnetic disk storage or another magnetic storage device, or any other medium that can be configured to carry or store required program code in a form of an instruction or a data structure and that may be accessed by the computer. In addition, any connection is appropriately referred to as a computer-readable medium. For example, if a coaxial cable, an optical fiber cable, a twisted pair, a digital subscriber line (DSL), or wireless technologies (such as infrared, radio, and a microwave) are used to transmit software from a website, a server, or another remote source, the coaxial cable, the optical fiber cable, the twisted pair, the DSL or the wireless technologies such as infrared, radio, and a microwave are included in a definition of the medium. Magnetic disks and optical discs used in this specification include a compact disk (CD), a laser disk, an optical disc, a digital versatile disc (DVD), a floppy disk, and a Blu-ray disc. The magnetic disks usually magnetically reproduce data, and the optical discs optically reproduce data by using laser light. The foregoing combinations should also be included within the scope of the computer-readable medium.

An embodiment of this application further provides a computer program product. All or some of the method described in the foregoing method embodiments may be implemented by using software, hardware, firmware, or any combination thereof When the methods are implemented in software, the method may be all or partially implemented in a form of a computer program product. The computer program product includes one or more computer instructions. When the foregoing computer program instruction is loaded and executed on a computer, the procedures or functions described in the foregoing method embodiments are all or partially generated. The foregoing computer may be a general-purpose computer, a special-purpose computer, a computer network, a network device, user equipment or other programmable apparatuses.

The objectives, technical solutions, and advantageous effects of this application are further described in detail in the foregoing specific implementations. It should be understood that the foregoing descriptions are merely specific implementations of this application, but are not intended to limit the protection scope of this application. Any modification, equivalent replacement, or improvement made based on technical solutions of this application shall fall within the protection scope of this application.

What is claimed is:

1. A terminal management and control method, comprising:
obtaining, by a session management network element, authorized communication information of a first terminal or a terminal group, wherein the authorized communication information comprises information about a device with which the first terminal or the terminal group is allowed to communicate;
when the first terminal or a second terminal in the terminal group communicates with a device not listed in the authorized communication information, learning, by the session management network element, that a management and control measure needs to be taken on communication of the first terminal or the second terminal; and
taking, by the session management network element, the management and control measure.

2. The method according to claim 1, wherein the management and control measure comprises any one or more of the following:
performing packet discarding processing on data, wherein the data is data exchanged by the first terminal or the second terminal with the device not listed in the authorized communication information;
when a quantity of times that the first terminal or the second terminal in the terminal group communicates with the device not listed in the authorized communication information exceeds a preset value, performing the packet discarding processing on the data;
performing reporting to a third-party device, wherein the third-party device is a device that manages the first terminal or the terminal group; or
when the quantity of times that the first terminal or the second terminal in the terminal group communicates with the device not listed in the authorized communication information exceeds the preset value, performing the reporting to the third-party device.

3. The method according to claim 1, wherein the learning, by the session management network element, that a management and control measure needs to be taken on communication of the first terminal or the second terminal comprises:
learning, by the session management network element by receiving the report information from the user plane network element, that the management and control measure needs to be taken on communication of the first terminal or the second terminal, wherein the report information is used to indicate that the first terminal or the second terminal communicates with the device not listed in the authorized communication information; or
learning, by the session management network element by receiving the data, that the management and control measure needs to be taken on communication of the first terminal or the second terminal, wherein the data is the data exchanged by the first terminal or the second terminal with the device not listed in the authorized communication information, and the data carries information about the device not listed in the authorized communication information,

4. The method according to claim 1, wherein the taking, by the session management network element, the management and control measure comprises:
receiving, by the session management network element, indication information from the third-party device, wherein the indication information is used to indicate that the management and control measure is taken when the first terminal or the second terminal communicates with the device not listed in the authorized communication information; and
taking, by the session management network element, the management and control measure based on the indication information.

5. The method according to claim 1, wherein the obtaining, by a session management network element, authorized communication information of a first terminal or a terminal group comprises:
obtaining, by the session management network element, the authorized communication information that is of the first terminal or the terminal group and that is from the third-party device; or
locally obtaining, by the session management network element, the authorized communication information of the first terminal or the terminal group.

6. A terminal management and control method, comprising:
obtaining, by a user plane network element, authorized communication information of a first terminal or a terminal group, wherein the authorized communication information comprises information about a device with which the first terminal or the terminal group is allowed to communicate;
detecting, by the user plane network element, that the first terminal or a second terminal in the terminal group communicates with a device not listed in the authorized communication information; and
taking, by the user plane network element, a management and control measure on communication of the first terminal or the second terminal,

7. The method according to claim 6, wherein the detecting, by the user plane network element, that the first terminal or a second terminal communicates with a device not listed in the authorized communication information comprises:
receiving, by the user plane network element, data, wherein the data is data exchanged by the first terminal or the second terminal with the device not listed in the authorized communication information, and the data carries information about the device not listed in the authorized communication information; and
detecting, by the user plane network element based on the information about the device not listed in the authorized communication information, that the first terminal or the second terminal communicates with the device not listed in the authorized communication information.

8. The method according to claim 7, wherein the management and control measure comprises any one or more of the following:
performing packet discarding processing on the data;
when a quantity of times that the first terminal or the second terminal in the terminal group communicates with the device not listed in the authorized communication information exceeds a preset value, performing the packet discarding processing on the data;
performing reporting to a third-party device, wherein the third-party device is a device that manages the first terminal or the terminal group; or
when the quantity of times that the first terminal or the second terminal in the terminal group communicates with the device not listed in the authorized communication information exceeds the preset value, performing the reporting to the third-party device.

9. The method according to claim 6, wherein the obtaining, by a user plane network element, authorized communication information of a first terminal or a terminal group comprises:
obtaining, by the user plane network element, the authorized communication information that is of the first terminal or the terminal group and that is from the third-party device; or
locally obtaining, by the user plane network element, the authorized communication information of the first terminal or the terminal group.

10. A session management network element, comprising:
at least one processor; and
a memory coupled to the at least one processor and storing executable instructions for execution by the at least one processor, the executable instructions instruct the at least one processor to:
obtain authorized communication information of a first terminal or a terminal group by using the communication unit, wherein the authorized communication information comprises information about a device with which the first terminal or the terminal group is allowed to communicate;
when the first terminal or a second terminal in the terminal group communicates with a device not listed in the authorized communication information, learn that a management and control measure needs to be taken on communication of the first terminal or the second terminal; and
take the management and control measure.

11. The session management network element according to claim 10, wherein the management and control measure comprises any one or more of the following:
performing packet discarding processing on data, wherein the data is data exchanged by the first terminal or the second terminal with the device not listed in the authorized communication information;
when a quantity of times that the first terminal or the second terminal in the terminal group communicates with the device not listed in the authorized communication information exceeds a preset value, performing the packet discarding processing on the data;
performing reporting to a third-party device, wherein the third-party device is a device that manages the first terminal or the terminal group; or
when the quantity of times that the first terminal or the second terminal in the terminal group communicates with the device not listed in the authorized communication information exceeds the preset value, performing the reporting to the third-party device.

12. The session management network element according to claim 11, wherein the management and control measure comprises performing the packet discarding processing on the data, and the executable instructions instruct the at least one processor to:
send a notification to a user plane network element by using the communication unit, wherein the notification is used to indicate to delete the data; or
delete the data.

13. The session management network element according to claim 11, wherein the management and control measure comprises performing reporting to the third-party device, and the executable instructions instruct the at least one processor to:
generate report information, and send the report information to the third-party device by using the communication unit, wherein the report information is used to indicate that the first terminal or the second terminal communicates with the device not listed in the authorized communication information; or
receive the report information from the user plane network element, and send the report information to the third-party device by using the communication unit.

14. The session management network element according to claim 10, wherein the executable instructions instruct the at least one processor to:
receive the report information from the user plane network element by using the communication unit, and learn that the management and control measure needs to be taken on communication of the first terminal or the second terminal, wherein the report information is used. to indicate that the first terminal or the second terminal communicates with the device not listed in the authorized communication information; or
receive the data by using the communication unit, and learn that the management and control measure needs to be taken on communication of the first terminal or the second terminal, wherein the data is the data exchanged by the first terminal or the second terminal with the device not listed in the authorized communication information, and the data carries information about the device not listed in the authorized communication information.

15. The session management network element according to claim 10, wherein the executable instructions instruct the at least one processor to:
receive indication information from the third-party device by using the communication unit, wherein the indication information is used to indicate that the management and control measure is taken when the first terminal or the second terminal communicates with the device not listed in the authorized communication information; and
take the management and control measure based on the indication information.

16. The session management network element according to claim 10, wherein the executable instructions instruct the at least one processor to:
obtain the authorized communication information that is of the first terminal or the terminal group and that is from the third-party device by using the communication unit.

17. A user plane network element, comprising:
at least one processor; and
a memory coupled to the at least one processor and storing executable instructions for execution by the at least one processor, the executable instructions instruct the at least one processor to:
obtain authorized communication information of a first terminal or a terminal group by using the communication unit, wherein the authorized communication information comprises information about a device with which the first terminal or the terminal group is allowed to communicate;
detect that the first terminal or a second terminal in the terminal group communicates with a device not listed in the authorized communication information; and
take a management and control measure on communication of the first terminal or the second terminal.

18. The user plane network element according to claim 17, wherein the executable instructions instruct the at least one processor to:
receive data by using the communication unit, wherein the data is data exchanged by the first terminal or the second terminal with the device not listed in the authorized communication information, and the data carries information about the device not listed in the authorized communication information; and
detect, based on the information about the device not listed in the authorized communication information, that the first terminal or the second terminal communicates with the device not listed in the authorized communication information.

19. The user plane network element according to claim 18, wherein the management and control measure comprises any one or more of the following:
performing packet discarding processing on the data;
when a quantity of times that the first terminal or the second terminal in the terminal group communicates with the device not listed in the authorized communication information exceeds a preset value, performing the packet discarding processing on the data;
performing reporting to a third-party device, wherein the third-party device is a device that manages the first terminal or the terminal group; or
when the quantity of times that the first terminal or the second terminal in the terminal group communicates with the device not listed in the authorized communication information exceeds the preset value, performing the reporting to the third-party device.

20. The user plane network element according to claim 17, wherein the executable instructions instruct the at least one processor to:
obtain the authorized communication information that is of the first terminal or the terminal group and that is from the third-party device by using the communication unit.
